(19) United States
(12) Patent Application Publication
(10) Pub. No.: US 2026/0041596 A1
(43) Pub. Date: Feb. 12, 2026

(54) RAPIDLY ADJUSTABLE WALKING STICK AND FOREARM CRUTCH

(71) Applicant: Aufstand AG, Berschis (CH)

(72) Inventors: Samuel DUTLER, Walenstadt (CH); Timon SCHWARZ, Tägerwilen (CH); Kasimir SCHWARZ, Tägerwilen (CH); Micha RUFF, Tägerwilen (CH); Jonathan HANHART, Seuzach (CH); Marco WALDER, Kreuzlingen (CH); Kevin MAUCHLE, Amriswil (CH)

(73) Assignee: Aufstand AG, Berschis (CH)

(21) Appl. No.: 19/292,103

(22) Filed: Aug. 6, 2025

(30) Foreign Application Priority Data
Aug. 7, 2024 (EP) 24193446.2

(51) Int. Cl. A61H 3/02; A61H 3/00

(52) U.S. Cl. CPC A61H 3/02; A61H 2003/006; A61H 2201/0192

(57) ABSTRACT

A walking aid with an apparatus for length adaptation by a control element on a handgrip of the aid. The aid has main and adjusting tubes which can slide into each other adapting the length of the aid and can be locked with and/or disengaged from one another with the apparatus for changing length. The apparatus has a slide that can be moved by the control element via a mechanism, and which transitions from a first level to a second level orthogonally to the direction of movement, and an engaging element. The engaging element can be moved by actuation of the slide—into a locked position in the first level, in which the engaging element engages in a recess or indentation on the adjusting tube, or—into an unlocked position in the second level, in which the recess or indentation of the adjusting tube can be released.

This application claims priority to European application EP24193446.2 filed 7 Aug. 2024.

### FIELD OF THE INVENTION

The invention relates to a walking and standing aid that is designed to change its length via a control element on a handgrip according to the preamble of the independent claim and a mechanism for changing the length of a walking aid, as well as a corresponding method for changing the length of a walking aid.

The invention relates in particular to walking and standing aids, for example crutches, walking sticks, walking canes, forearm crutches, armpit supports, walkers, standing aids, etc., of which the length or height between handgrip and ground can be adjusted during use. Among other uses, walking and standing aids of such kind can make it easier to stand up from a sitting position if the walking and standing aid has a shorter length, adapted to the sitting position before or while standing up, and if its length can be adjusted to a longer length, adapted to the standing position after standing up. Such a length adaptation may also be advantageous when the user is climbing steps or stairs, would like to bend over, to pick something up from the floor, etc.

### BACKGROUND OF THE INVENTION

An example of such a walking aid is presented in DE202004011326U1, for example. In this document, instead of a positioning element supported elastically on the tube which can be operated to adjust length, an arrestable pneumatic apparatus is suggested, similar to those also described in WO12121492, CN111135022, U.S. Pat. No. 7,350,531 or WO2020117839.

In DE20108176U1, a configurable gas pressure spring is fitted in a walking aid and serves to prevent an injured leg from being exposed to a load exceeding a defined maximum as the gas pressure spring yields. A similar principle is also applied in US2011271992.

U.S. Pat. No. 2,630,128 describes a crutch with a height-adjustable handgrip, on which a pin is operable directly in the grip via an axial slide to engage in two reciprocally displaceable tubes, and with which the height of the grip as well as the length of the tubes are adjustable with respect to each other. In the inactivated state it engages in recesses in an interior tube, thus enabling a relative position between handgrip and ground to be shifted. In a lowered position, the interior tube must be able to project upwards above the grip correspondingly.

U.S. Pat. No. 3,157,188 suggests a hydraulic solution, whose construction is however very complicated and elaborate, particularly with the motor-pump unit that is essential therefor and the battery necessary for it, with which passive operation is impossible. U.S. Pat. No. 4,252,138 describes a toothed rack mounted on the outside of a crutch and a pawl which engages therein to release/fix a height adjustment arrangement. The many external components that protrude in this case are not only awkward to use (catching, unintentional triggering when struck, etc.), but in some cases even pose a risk of injury.

In any know interior mechanisms with bolts, toothing or similar, the upper, smaller tube is pushed into the larger, lower tube, because this is the only way to mount the mechanism fixedly in the upper tube and maintain the distance from the actuation mechanism on the grip. However, a tube size arrangement of such kind is actually inconsistent with the mechanical strength requirements. Moreover, many of the mechanical solutions used in this way, such as U.S. Pat. No. 5,036,873 or CN207492927, take up a great deal of space inside the tube or occupy practically the entire cross-section thereof, and are also correspondingly complex and correspondingly heavy.

The known solutions are beset with disadvantages in one respect or another, either with regard to handling, complexity and cost of implementing the solution, number and assembly of the required components, weight, reliability, durability, safety, etc. Some of these disadvantages have been described above for exemplary purposes.

### SUMMARY OF THE INVENTION

Accordingly, the object of the present invention is to produce an apparatus and provide a method in which the abovementioned disadvantages are overcome or minimised. In particular, it is intended to provide an improved walking aid. Specifically, a walking aid whose length is adjustable from the handgrip and which is robust, reliable, and simple to operate, maintain and adapt for an individual user.

Particular objects besides simplifying the construction and improving reliability also include avoiding/reducing safety problems, for example.

In particular, producing a mechanism that can be integrated in a walking and standing aid and provides a compact latching device between two tubes of a walking cane which can be released with little force may also be considered an object.

The objects are solved by the features of the independent claim. Advantageous further developments and embodiments are presented in the figures and the dependent claims, and in the following description.

According to the invention, a walking aid having an apparatus for changing its length by means of a control element on a handgrip of the walking aid is provided. In particular, such a walking aid may be designed as a supporting or load-relieving walking aid, such as a walking cane, walking stick, multibase walking aid, cane, forearm-crutch or forearm walking support, armpit crutch or armpit support, or arthritis walking support, but may also be embodied as a walker or walking frame, for example, such as a mobility walker or rollator according to the invention. Similar to the classic design by Emile Schlick and/or Louis Lucien Lepoix (FR479036A, U.S. Pat. No. 1,244,249A), for example.

In this context, the walking aid is designed with a main tube and an adjusting tube which is displaceable longitudinally relative to the main tube. These can be slid or telescoped into one another to change length, wherein the adjusting tube may be displaceable in the lengthwise direction of the tube inside the main tube, or conversely the main tube may be displaceable inside the adjusting tube, depending on the design. Main tube and adjusting tube can be locked in position or released relative to one another with the length changing apparatus. Thus, the length of the walking aid, specifically the length between handgrip and ground, can be fixed in at least two defined length positions and released to allow changing between the length positions.

According to the invention, this apparatus includes a slide which is movable via a mechanism by the separately located control element. This slide has a transition—substantially orthogonally to the direction of motion thereof—from a first level to a second level.

According to the invention, the apparatus also has an engaging element which, upon actuation of the slide

engages in a locked position in the region of the first level—in which the engaging element engages in a recess or indentation in the adjusting tube, in particular under force,—or,
can be brought into an unlocked position in the region of the second level—in which the recess or indentation in the adjusting tube can be released by the engaging element, in other words in which the engaging element does not engage in the recess or indentation under force, but rests thereon, loose or with clearance, for example. In other words, a preferred embodiment of the slide has a first level and a—preferably smooth or steady—transition to a second level—wherein these levels do not necessarily have to be flat, but are defined mainly by the fact that they are substantially parallel to the main tube. In this context, “substantially parallel” particularly includes a slight inclination of a few degrees, which is designed so as produce a securing effect against releasing under load (clamping and self-locking effect under load between main tube and adjusting tube)—for example less than 5 degrees or preferably less than 3 degrees of inclination in the direction in which said securing effect operates.

The engaging element may be in particular a roller element, specifically for example a cylindrical roller or a ball. With such a shape, the change from engagement to release can take place advantageously, in particular with little or no danger of jamming, tilting or catching, and with minimal friction and consequently little or no application of force for engaging/releasing. In this way in particular—unlike with a bolt or similar, for example—a separate element for applying a restoring force to the engaging element is unnecessary, which makes the design simpler and reduces the number of components that can become misaligned or break. This in turn serves to improve reliability. The transition may preferably be a continuous or smooth transition, in other words it may be a “fluid” transition between the two levels, for example in the form of a bevel, tilted level, curve, etc., and advantageously for example not in a rectangular stage. In this way, actuation of the engaging element can be improved, in particular so that tilting, catching or the like can be prevented—and reliability can be improved.

The mechanism may preferably be a purely mechanical mechanism, that is to say in particular with no electrical or pneumatic or hydraulic components (i.e., non-electrical and/or non-pneumatic/hydraulic), for example with mechanical pull- or push-rods, levers, cords, rollers, toothed mechanisms, etc. This enables functioning without the need for a power supply and little or no maintenance. The slide may preferably be fitted on the main tube and displaceable relative thereto by means of the mechanism.

Thus, with the invention a user of the walking aid can safely and reliably release or lock a length locking mechanism of the walking aid as needed from the handgrip. At the same time the load-bearing capability is reliably assured in the blocked state. In particular, the apparatus according to the invention used in such a case can be installed in compact and space-saving manner in or on the walking aid. Not least because of its simple, mechanical construction, the requisite reliability and low maintenance requirement can be obtained, and an efficient, inexpensive construction involving few or no costly special parts may be achieved.

In the preferred embodiment, the main tube may have a larger cross-section than the adjusting tube, so the adjusting tube may be inserted in the main tube, although in another embodiment according to the invention the main tube may also have a smaller cross-section than the adjusting tube, so that the main tube can be inserted in the adjusting tube.

According to the invention, the top (farther from the ground) tube preferably has a larger cross-section than the bottom tube (closer to the ground). In such a case, the top tube is preferably the main tube. Alternatively, however, in another embodiment the adjusting tube may also be the top tube (see also the preceding paragraph). In this way a favourable geometry can be created, in terms of statics and/or ergonomics, for example.

In a special embodiment, the actuating force may be transmitted via a cord, a Bowden cable or a wire, which is routed inside the walking aid or inside the tube, so that it is not accessible or visible from the outside. At the same time, however, the arresting mechanism may still be arranged at least partially outside the top tube and connected mechanically to the internal cord. This in particular saves space in the tube and thus enables the gas pressure spring to be installed inside. Besides the compact construction and advantageous appearance, this has the further benefit of protecting the components.

More preferably, the slide is designed and arranged in such manner that it is moved parallel or substantially parallel to the main tube, or axially along a longitudinal direction of the main tube. Thus for example, a linear displacement of the slide in the direction of the tube axis or a movement substantially in direction of the tube axis, for example by tilting a slide through a slight angle, e.g. less than 20 degrees about an axis of rotation, which is practically equivalent to a linear motion, or also by rotating a round slide about the axis of the tube, which is also equivalent to a linear movement considered tangentially to the engaging element. In all these movements, as described previously, a transition takes place from the first to the second level, wherein these levels are defined in that they are at different distances from the tube axis radially and/or orthogonally to the tube axis. This makes an “engagement” of the first or second level possible with an easily performed movement that can be actuated from the control element. With these movements, reliable motion can also be carried out without danger of tilting or jamming.

In another embodiment, the levels according to the invention may also be designed as a transition between two different radii of a round slide, which is moved/rotated between a locked and released position by turning between these two levels about the tube axes when the control element on the handgrip is operated.

In particular, the slide may be biased in the locked position by a spring element. This biasing may be exerted directly, that is to say locally at the slide, or in a different configuration indirectly or separately from the slide via the mechanism. In this way, it can be ensured that, when not actuated as well as in all spatial positions, the safe, locked state is taken up by default and when whenever possible.

In one embodiment, the engaging element may be held loose in a cage, in this case in particular the engaging element may be retained in a position in that region of the adjusting tube in which the recesses or indentations are located. Specifically, the slide may also be designed such that the slide holds the unlocked engaging element in position. Accordingly, the engaging element may be kept loose and easily movable, while at the same time ensuring that it is always located in one position. According to the invention, the apparatus for locking may also be provided on two or more sides of the main/adjusting tube, preferably symmetrically or evenly distributed about the circumference of the tubes, and adapted to the load during use of the walking aid—which in turn increased stability, safety, reliability, etc.

The apparatus may preferably be arranged on the end of the main tube farthest from the handgrip. In this way, it is possible to ensure secure locking both in the fully extended and the fully retracted state, as well as in an intermediate position if provided.

The mechanism may be designed with a pull cord inside the main tube, for example, via which the slide is actuated/moved. The pull cord may be routed in particular between main tube and adjusting tube. Thus, it can be arranged so as to be protected in the interior of the walking aid. At the same time, it is then also to accommodate the spring element—which will be explained below—in the interior of the walking aid as well.

The control element may be connected directly to a pull cord or Bowden cable as described earlier, and act thereon to directly move the slide mechanically by this means.

More preferably, the control element may cause the movement of the slide purely mechanically via a lever assembly inside the handgrip directly via a linkage and/or via the pull cord or Bowden cable. Optionally, the lever assembly may form a safety interlock that protects against unintentional unlocking and/or actuation. In one embodiment, for example, a two-point operation with simultaneous actuation of two spatially separate control elements may be provided for unlocking. In another embodiment, the safety interlock may be designed such that the actuation can only take place with a combined movement, e.g., pressing+sliding or turning+pressing or similar. For example, securing against unintentional actuation may be assured by equipping the thumb slide with a spring as well, so that it must be pressed in first, before sliding it backwards (or forwards) in order the allow this direction of movement.

The control element may be specially arranged on the side of the walking aid handgrip in such a way that it can be operated by a user with their fingers, preferably with the thumb while holding the handgrip. A thumb slide fitted laterally in this way allows ergonomic actuation with closed hand, that is to say while holding the handgrip securely and firmly.

The control element may be designed specially with a force limiting element, which is designed in such a way that a force transmitted thereby is only sufficient to move the slide when the walking aid is not supporting a user—whereas when the walking aid—and consequently the slide—is supporting a load, this force is not sufficient to move the slide. The force limiting element may have the form of a force limiting spring, for example. This serves as in addition or alternatively to the safety interlock to prevent the user falling due to unintended release of the locking mechanism while the walking aid is under load in use.

In one embodiment, the handgrip may be designed with a replaceable outer grip plate. The replacement may include the part of the control element that is in contact with the hand, or this part may remain on the walking aid during replacement. This enables it to be adapted to the ergonomics of the user's hand, left-handed or right-handed use, hand size, replacement due to wear, etc. For example, a handgrip shape adapted individually for a specific user may be provided for example based on a hand scan or impression, by means of 3D printing, a hand imprint, a casting or by machining. The grip plate may be attached by means of a quick fastening such as a plug, magnet, or simple screw connection to enable different variants (size and shape) to be replaced rapidly.

In one embodiment a permanent magnet may be present in the handgrip or in the area of the handgrip, which is designed and arranged to create a connection to a second walking aid or to a metal object. This may serve for example to prevent the walking aid from falling over or to enable fall-safe positioning of the walking aid when the user needs a hand free.

In one embodiment, the grip may be constructed without a grip plate with a mirror-symmetrical design—specifically symmetrical about its perpendicular bisector surface—thus forming a replaceable thumb slide side, enabling the same walking aid to be configured for right- or left-handed use, for example. This enables the walking aid to be used in many different situations with no product variation of its principal technical components.

The main and/or adjusting tube may preferably have a non-circular cross-section as well as a circular cross-section. Specifically wherein the cross-section of the adjusting tube is of flat/planar structure in the region of the engaging element—the engaging element thus slides or rolls over the flat region during a change in length. In particular, main and/or adjusting tube may be shaped with an oval or elliptical or flattened circular cross-section which is flattened at the major vertices. An oval tube profile with flat frontal faces offers a number of advantages such as:

Sufficient space in the tube for steel cords, Bowden cables or other mechanical components for transmitting motion between handgrip and slide. Particularly if a spring element, e.g., a usually circular gas spring or coil spring is fitted in the interior, a non-circular tube cross-section affords enough space for a mechanical connection between slide and actuating element. In particular, this also leaves space on two substantially opposite sides of the tube cross-section, so that a locking mechanism can be implemented on both of these sides, thus increasing for example stability, safety reliability, etc.

A non-circular tube-cross-section of such kind also offers high flexural stiffness about the x-axis—i.e. the vertical walking direction—thereby enabling low weight and slimline design of the walking aid tubes, and/or space inside the tubes for the mechanical components of the apparatus according to the invention in synergy with a high mechanical load-bearing capacity matched with the usual usage.

A non-circular tube-cross-section of such kind also offers a safeguard against twisting of main tube and adjusting tube relative to one another. Besides safety when walking, this also assists reliable engagement of the engaging element.

Particularly in embodiments with an engaging element in the form of a roller, e.g., a cylindrical roller which partly engages in a horizontal slot for locking, a flattened or flat cross-section region enables a straight contact area for the rollers. This enables the material stresses generated to be reduced, for example, or smaller dimensioning is sufficient.

With the flattened or flat cross-section region or sides, an advantageous, integrated guide surface for sliding blocks and/or the engaging element can also be provided, which can help to prolong service life with daily retraction and extension operations for example.

However, embodiments with (circular) round tubes may also provide an embodiment of the invention. In such cases, for example, the slide may also be at least particularly or entirely round. The motion of the slide may generally and specifically in this case also be produced by tilting through a small angle about a substantially horizontal axis of rotation or also by rotating the slide about a longitudinal axis of a tube, which according to the invention results in switching between the at least two different levels acting on the engaging element.

According to the invention, a single engaging element may be present for the implementation of the invention per individual walking aid, but it is more preferable if a number of engaging elements are present on each main and adjusting tube. For example, two engaging elements may be present, specifically one engaging element on each side of the adjusting tube. For example, one engaging element each may preferably be arranged on opposite sides of the tube, specifically on the two opposite, flat sides of the main and/or adjusting tube. In such a case, these multiple engaging elements may preferably be controlled on one tube by means of the same slide. Thus, the use of two or more rollers may serve to ensure better detent and/or redundance for preventing a failure, and/or it may bring about better load distribution, with lower forces, longer service life or smaller dimensioning in each case.

In a walking aid according to the invention, a spring element is preferably arranged in the interior of main and adjusting tube, via which the main tube and adjusting tube are movably connected to each other. The spring element may be designed and arranged in such manner that the change of length of main tube with respect to the adjusting tube in an unloaded state is brought into an expanded first stage travel position. For example, a fully extended position of the spring element may correspond to a maximum length latching position of the apparatus for locking, and/or a fully retracted position of the spring element may correspond to a minimum length latching position of the apparatus for detent. In such case, the spring element is designed so that it can be compressed by the user as far as the lowest latching position by applying load to the handgrip, and upon release of the load or application of only very little load the walking aid extends as far as the highest latching position. For example, the minimum necessary load for compressing may be less than bout 15 kg, e.g., preferably less than about 6 kg, and the low load, above which the extension begins, may be for example below 4 kg or 2 kg or less. In this way, reliable retraction and extension of the walking aid length changing arrangement is improved.

In one embodiment a stronger spring force may optionally be provided as well, which provides the user more pronounced feedback and/or stronger support when standing up, with a load for extension configurable with <4 kg or <15 kg for example, depending on the user's wish.

More preferably, the spring element is embodied as a gas pressure spring. This may be designed in particular with a damped or limited extension speed. Additionally or alternatively, this may also be designed with a force progression that is substantially constant over the travel path. Optionally, the spring element may also be designed to allow the setting of different strengths and/or force requirements for compression, and the walking aid may be constructed to allow easy replacement of the spring element. For example it may be detachable between main and adjusting tube, preferably with little effort, e.g., without the need for tools or with only a small number of screws, etc. For example, the spring element or gas pressure spring may be secured with a spherical or cylindrical bearing, which allows rapid, simple installation and absence of torque during operation. Thus, the walking aid can be operated efficiently and can be adapted flexibly to user needs without having to provide a wide range of different walking aids.

In an alternative embodiment, the spring element may preferably be constructed with compression springs, with coil springs, for example. In addition to a single, long compression spring, in particular with a series arrangement of at least two individual compression springs. In this way, a less complex and less expensive solution may be provided than with the gas pressure spring. For example, the walking aid may also be designed in such a way that the gas pressure spring or usual compression spring are interchangeable, for example as different product variants or upgrades. In such case, a reliable guide inside the walking aid may be provided with sliding elements/rings along the length of the spring, and/or with sliding elements/rings that connect the individual compression springs to each other, and so reduce buckling, misalignment and friction of the spring in the interior of the adjusting and/or main tube.

More preferably, the walking aid may be designed such that at least one further intermediate latching position of the apparatus is provided and/or created between maximum and minimum length change of the walking aid. In this context in particular, the adjusting tube may have more than two recesses or indentations for distinct length changes of different values, for example 3, 4 or 5 distinct length stages. This may help to make standing up from different heights easier.

The slide and/or handgrip may preferably provide or be connected to an optical indicator that is visible from the outside. This indicator may show that or whether the length adaptation is in the locked position and/or the unlocked position. For example, the moving position of the slide may be made visible to the user of the walking aid via an indication element, a sight glass or similar. This offer additional safety for the user, and a reliable function of the length adaptation may be seen clearly from the outside.

More preferably, in one embodiment of the walking aid the handgrip is arranged on the end of the main tube. Alternatively or additionally, a collar tube with a collar or armpit support may also be arranged on the free end thereof on the handgrip above the main tube. The collar tube may also be angled or curved with respect to the main tube. Particularly if the apparatus is arranged on a bottom end or the end of the main tube opposite the handgrip, it is thus possible to create sufficient length adaptation and an overlap of main tube and adjusting tube that is long enough to ensure stability for any walking aid length—which would not be possible if a locking mechanism were provided in the area of the handgrip.

In one embodiment at least the adjusting tube or the main tube is preferably constructed in two parts, with an engaging base tube that is displaceable inside said tubes and can be operated to lock in place in different stages.

For example, the base tube may be arranged inside the adjusting tube, and may be engaged in holes in different basis length positions by means of locking spring, spring lugs, spring studs, spring pressure fitting, clip/pin, screw, swivel clamp system, quick release levers, toggle levers, etc.

Particularly in this case, a foot part may be attached to the free end of the adjusting tube, farthest from the main tube. The foot part may form a ground grip bumper or cane bumper, e.g., in the form of a rubber foot or spike, or a multibase, e.g., tripod, quadrupod, etc., to provide additional stability.

In other words, the walking aid provides a dual telescopic tube system. Of these, one telescope mechanism—preferably the lower one—can be locked locally and permanently and serves to make the one-time basis length adaption to the size of the user's body, in a similar manner to conventional crutches, e.g., with spring stud, screws, toggle levers, pin, screw, rapid adjustment etc. The second telescopic mechanism—preferably the upper one—can be locked and/or released from the handgrip according to the invention and serves to rapidly adjust the length, e.g., via gas pressure spring when standing up, sitting down, etc.

The invention relates in similar manner to a method for changing the length of a walking aid by means of a handgrip control element. In particular, a walking aid may be embodied as described in this document, but the method according to the invention may also be applied for walking aids of different structural design, particularly if such design includes the minimum essential elements of an apparatus according to the invention in the form of the slide and the engaging elements.

In this context, the method according to the invention comprises at least:
actuation of a control element on the handgrip of the walking aid, preferably a lateral actuation with a thumb,
movement of a slide arranged separately from the handgrip by actuation of the control element via a mechanism, in particular wherein the movement is caused by actuation with a purely mechanical transmission,
release of an engaging element from an latched position in an adjusting tube of the walking aid via the slide,
movement of the adjusting tube with respect to a main tube into a different latched position that corresponds to a different length of the walking aid,
ending the actuation of the control element, and
moving a slide back with a forced engagement of the engaging element in the other latched position.

More preferably, in this case a biased movement of the walking aid into an expanded length by means of a spring element inside the walking aid takes place in the unloaded state of the walking aid. This makes both operation and standing up easier.

Further advantages, features and details of the invention are presented in the following description, in which exemplary embodiments of the invention are described with reference to the drawing.

The list of reference numerals also constitutes part of the disclosure, as do the technical content of the claims and the figures. The figures are described coherently and comprehensively. The same reference numerals stand for identical parts, reference numerals with different indices denote functionally equivalent or similar components.

### BRIEF DESCRIPTION OF THE DRAWING(S)

In the drawing:

FIGS. 1a and 1b represent an embodiment of a walking aid according to the invention in extended and retracted state,

FIGS. 2a, 2b and 2c represent an embodiment of a walking aid according to the invention in side view, rear view and plan view,

FIGS. 3a, 3b and 3c represent a cross-sectional view of an embodiment of a walking aid according to the invention with locked actuating mechanism and detail views thereof,

FIGS. 4a, 4b and 4c represent a cross-sectional view of an embodiment of a walking aid according to the invention with unlocked actuating mechanism and detail views thereof,

FIGS. 5a, 5b represent detail views of further variants of a spring assembly of a walking aid according to the invention,

FIGS. 6a, 6b represent detail views of a first further variant of an actuating mechanism of a walking aid according to the invention,

FIGS. 7a, 7b represent detail views of a second further variant of an actuating mechanism of a walking aid according to the invention,

FIGS. 8a, 8b represent a cross-section of a variant of the main and adjusting tubes with actuating mechanism,

FIG. 9 is a cross-sectional view similar to DETAIL B in FIG. 3a and FIG. 3b as well as FIG. 4a and FIG. 4b in another embodiment.

### DETAILED DESCRIPTION OF THE INVENTION

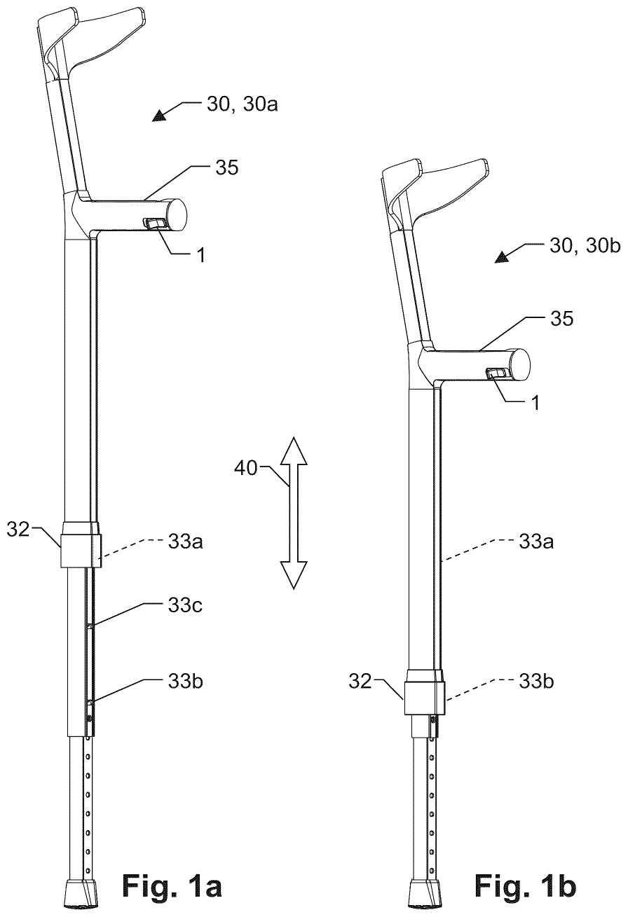

FIG. 1a shows an example of a species-related walking aid 30, shown here in an exemplary embodiment as a forearm crutch. This is designed according to the invention with a length adaptation 40, which is operable with a control element 1, shown here in exemplary embodiment as an actuating element in the form of a thumb slide, on the handgrip 35 of the walking aid. Shown here is the walking aid 30 in fully extended state 30a, in which the apparatus 32—which forms a detent and locking mechanism for the length adaptation 40 and is operated via the actuating element 1 on the handgrip 35—retained in locked position in the setting of the uppermost length position 33a, in which an engaging element is engaged in the recess or indentation 33a.

FIG. 1b shows the walking aid 30 of FIG. 1a with the length adaptation 40 in retracted state 30b. Said apparatus 32 is engaged in locked position in the setting of the lowest length position 33b, with the engaging element engaged in the recess or indentation 33b. According to the invention, at least two distinct length positions 40 or stages with two detents or recess or indentation 33a, 33b are present, although optionally one or more, for example 2 or 3 such intermediate stages 33c may also be embodied. In such case, however, according to the invention there is no length adaptation 40 of the walking aid 30 to the user—which advantageously creates many intermediate stages to provide wide variability—with the apparatus 32 according to the invention. According to the invention, the length adaptation 40 with the apparatus 32 is carried out in exactly 2 (or at all events 3, 4 or 5) distinct stages 33a, 33b, 33c, in order to provide a sitting or standing-up position/length 30b and a standing position/length 30a. Optionally, at most one or two more intermediate positions/lengths 30c may be present, to allow for different sitting heights, for example. In between, there is preferably no provision made for finely graduated length change—on the contrary, such a fine graduation might even be considered obstructive to the primary function of the invention. The length change 40 (min/max) according to the invention is for example more than 15 cm, for example about 20 cm to 40 cm, specifically for example about 25 cm, and/or for exemplary purposes preferably more than 5 cm or more between the detents 33.

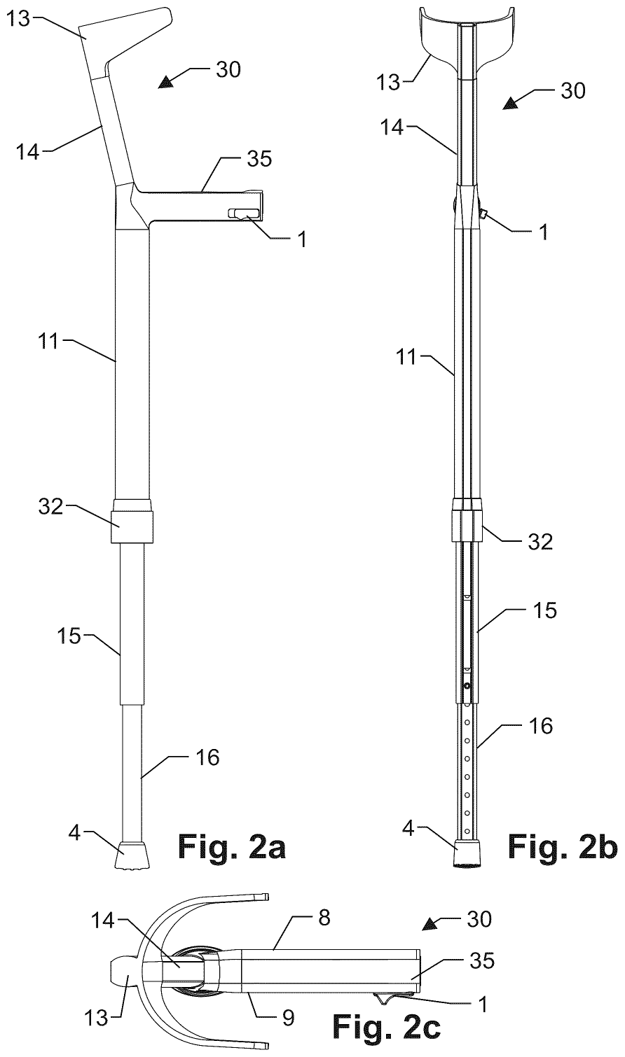

FIG. 2a shows a side view of a walking aid variant 30, with a handgrip 35 with an exemplary embodiment of a control element 1, which is mounted on or above a main tube 11. In this example, a collar tube 14 with a collar 13 is also mounted over the handgrip 35 or main tube 11, but these are optional, and do not have be present in other embodiments. For ergonomic reasons, the collar tube 14 is inclined backwards with respect to the main tube 11 and not over it in straight extension. Alternatively to the collar, in another embodiment a forearm crutch or armpit support or other might also be present.

The apparatus 32 is arranged in the region of the bottom end of the main tube 11 farthest from the handgrip 35 and provides a connection between main tube 11 and adjusting tube 15 according to the invention that can be disengaged and engaged via the handgrip.

A foot part 4, here a rubber foot in the form of a ground grip bumper, is mounted on the bottom part of the walking aid 30, which comes into contact with the ground. In other variants, a spike or other slip protection, or also a multibase, e.g. a tripod or quadrupod, etc., may be provided.

This figure also shows the optional, preferred variant of a dual telescoping arrangement, with an additional base tube 16 at the very bottom, at the lowest end of the adjusting tube 15, which are designed to lockable fixedly in their length and only locally displaceable—as known for example from classic walking canes with spring studs or beads that engage in holes and must be pushed in locally by hand to allow a displacement. These provide the capability to adjust to the user's body size, preferably in a smaller grid dimension than with the apparatus 32, specifically for example smaller than 5 cm, e.g., about 2 cm, 2.5 cm or 3 cm or 4 cm. These are shown particularly clearly again in the rear view of the walking aid 30 in FIG. 2b.

FIG. 2b shows a rear or back view of a walking aid variant 30 of FIG. 1a. The labelled elements correspond to those which have been explained previously and elsewhere.

FIG. 2c shows a plan or top view of a walking aid variant 30 of FIG. 1a and FIG. 2b. The labelled elements correspond to those which have been explained previously and elsewhere. This explicitly shows an embodiment in which the handgrip 35 optionally with replaceable grip form, for example with replaceable left-handed grip plate 8 and right-handed grip plate 9 on a grip core. Consequently, the same walking aid can be adapted to address specific grip requirements and wishes of different users quickly and easily, e.g., also for right-handed and/or left-handed users. In this context, the control element 1 or in particular the interior actuation thereof is preferably constructed in the grip core in such a way that it can be actuated from a variety of spatial positions, in particular from left to right, with the external operating element 1.

In one embodiment, the control element 1 can be secured against unintentional actuation. For example, actuation may require so much force that unintended touching is not sufficient to trigger it, or it may require a combined movement such as pressing+sliding or rotating+sliding or rotating+pressing or something similar, or a two-element operation may be needed to actuate the control element at all. In another configuration of a variant for securing against retracting by mistake, the slope of the slide surface 18a may be chosen such that the cylindrical roller under load presses the slide 18 towards the arrested position, locking it securely—upwards in the example shown.

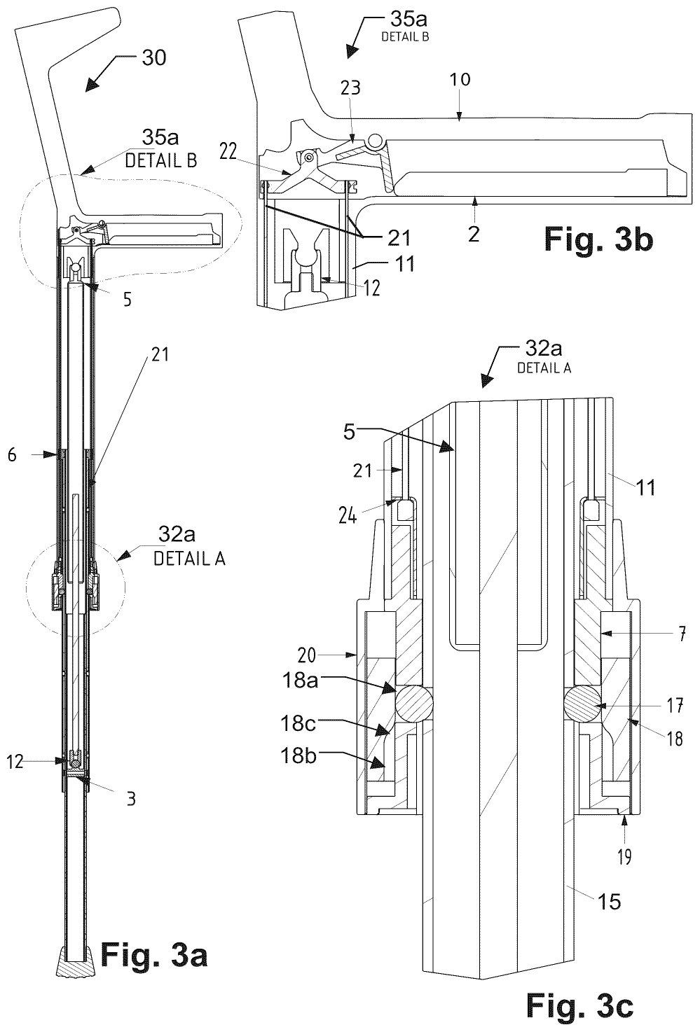

FIG. 3a shows a cross-section through an embodiment of a walking aid 30 according to the invention—similar to FIG. 2a. In addition to the elements described previously, it shows a spring element 5—here in the form of a gas spring 5—in the interior of the walking aid 30, via which the walking aid 30 in unloaded state or loaded below a threshold value with unlocked apparatus 32 extends to its maximum length. In this context, the speed and/or force of the movement may optionally be predetermined in a defined way or at any rate also adjustable by the spring element 5. The gas pressure spring 5 shown in this example is supported from above and/or below by a ball pocket 12, via which the gas pressure spring 5 is connected to the main tube 11 and handgrip 35 on the one hand and to the adjusting tube 15 via the spring fastening 3 on the other. Besides the spring element 5, a cord 21 or a pull rod is also shown in the interior as part of the mechanism for moving the slide of the apparatus 32.

The detail view in FIG. 3b from FIG. 3a shows another, enlarged view of the handgrip 35. In this exemplary embodiment of the mechanism—by means of which the slide is moved remotely, in particular around a corner between main tube 11 and handgrip 35 when the control element 1 is actuated—here the control element 1 and the mechanism connected thereto is shown with the apparatus 32a in the locked position, that is to say when control element 1 is not actuated. The mechanism may also be of different design within the scope of the invention, although it is preferably purely mechanical, i.e., it functions without electrical, pneumatic or hydraulic elements. In the example shown, a pressure bar 2 in the interior of the grip core 10 is connected to the control element 1—not shown—and acts on a rocker 23 with which a pull cord 21—in this example two pull cords 21—is movable over a balance 22, that is to say a tensile force can be exerted on the cords 21. In the locked or arrested state as shown, cords are preferably drawn taut, but not under tension.

In the detail view in FIG. 3c from FIG. 3a, the apparatus 32a mounted on the main tube 11 is shown—in the arrested state, that is to say with the control element 1 not actuated. The engaging element 17—in the exemplary embodiment shown, on two sides, in other variants also only on one side—engages in a recess or indentation in the adjusting tube 15, with the result that they are locked with respect to each other. In this situation, the cord 21, which in this example is connected to the slide 18 via a tension plate 24, is not pulled (upwards)—and the slide 18 is not actuated, and consequently the first slide level 18a thereof interacts with the engaging element 17, which is in locked position under force. The one or more engaging element(s) 17 may be held loose in a cage of apparatus 32. Here, the slide is supported in a slide housing 20 of the apparatus 32, the housing being closed with a slide cover 19. In this example, this slide housing 20 also forms slides 7 for the adjusting tube 15.

Now if the control element 1 is actuated, the rocker 23 is actuated via the pressure bar 2 and raises the balance 23 so that the cord 21 is drawn upwards. Inside the apparatus, the slide 18 is also moved upward by the cord 21 via the tension plate 24, with the result that, rather than the first level 18a—via the transition 18c—the second level 18b interacts with the engaging element 17—and consequently the adjusting tube 15 is also disengaged from the main tube 11.

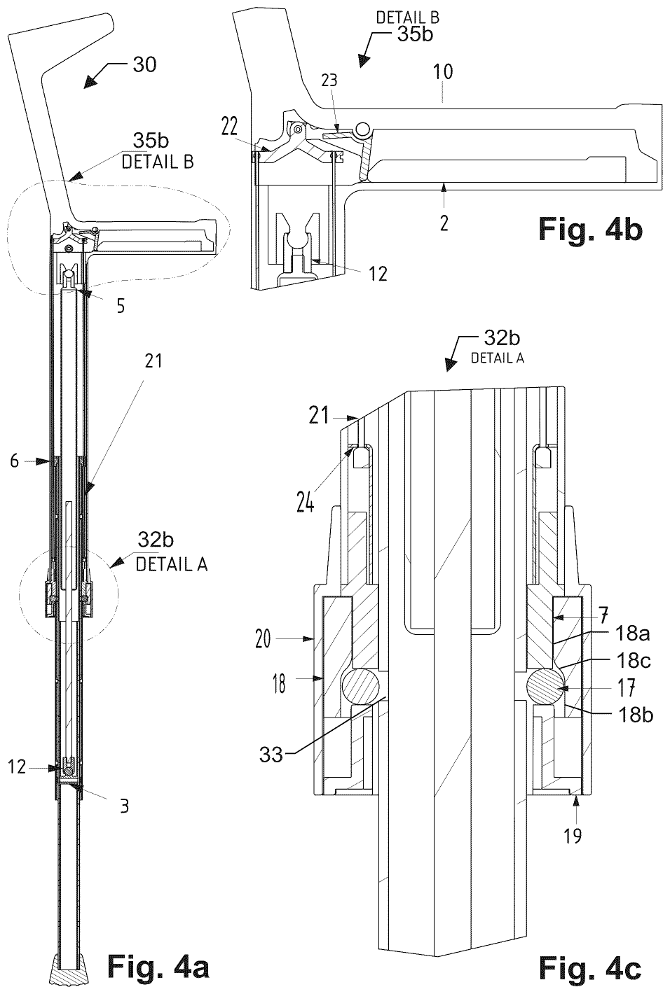

This is also represented again in the following set of FIGS. 4a, 4b, 4c, which shows similar illustrations to those in the set of FIGS. 3a, 3b, 3c—but in the unlocked state, with the control element 1 actuated. The designators follow the same conventions as in the previous figures.

FIG. 4a shows a cross-section through an embodiment of a walking aid 30 according to the invention as in FIG. 3a—but in the unlocked state, as described earlier.

The detail view FIG. 4b with 35b shows the handgrip 35 in the unlocked position, compared with FIG. 3b.

The detail view FIG. 4c with 32b shows the apparatus 32b also in the unlocked position, compared with FIG. 3c. In this case, level 18b of the slide 18 releases the engaging element 17, which is no longer engaged under force in the recess or indentation 33 in the adjusting tube 15—but instead releases it for adjusting the length of the walking aid 30.

The slide 18 is preferably biased into the locked position of 18a by means of a spring or similar (not shown here). For example, the slide 18 may be pressed downwards into a resting position by compression springs. After adjusting tube 15 has been unlocked and moved relative to main tube 11, so that the engaging element 17 is no longer positioned above the indentation or recess 33 in the adjusting tube 15, the control element 1 can be released again, and at a subsequent length position, in which the engaging element 17 is again positioned over a (different) indentation or recess 33 on the adjusting tube 15, an automatic locking follows as the engaging element 17 engages again there.

The engaging element 17 is preferably a roller element, that is to say for example a cylindrical roller (=as shown) or a ball, etc. This enables the engagement and release with favourably little force application and low tendency to cant.

As is also shown in the example, the transition 18c between the two levels is preferably continuous, that is to say not a rectangular step, but a smooth progression, e.g., in the form of a sloping level a curve, a rounding, etc. This in turn helps to reduce the tendency to cant and the force application. The levels 18a and/or 18b do not necessarily have to be exactly plane surfaces, but the term “flat” here is to be understood more in the sense of a storey, i.e. a differing distance from the side wall of the main tube and adjusting tube. These may certainly deviate by a few degrees from the side wall of the tube, for example, that is to say they may be slightly sloped or even bulging.

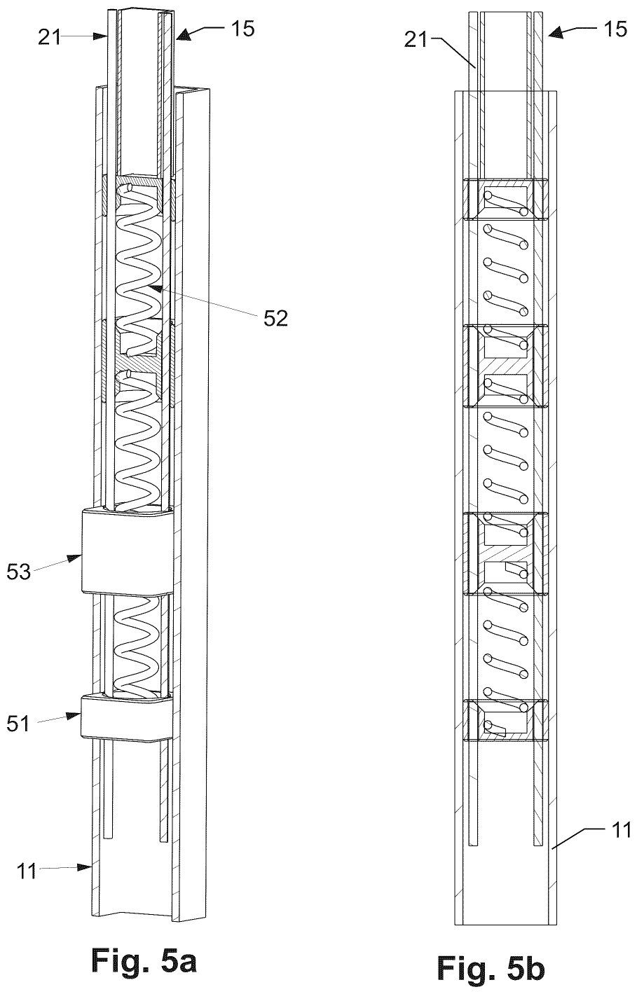

FIG. 5a shows a detail of a partial cutaway cross-section of a walking aid variant 30 in a region of the spring element 5. In this variant, a spring element 5 is shown in the interior of main tube 11 and adjusting tube 15 instead of (or possibly also in addition to) the gas pressure spring 5 described earlier. In this variant, the spring element 5 is constructed from a series arrangement of multiple single springs 52, shown here as spiral compression springs 52. Besides another, also possible variant, in which a single, long spring is used, the series arrangement makes it possible to create a simpler, safer guide for the spring(s) inside the tube with little or no friction canting, buckling of the springs in the tube interior or unintended jamming of the pull rod or cord 21. In this situation, the individual springs 52 are connected to each other with two-sided spring guides 53 and braced against the tube 11. A one-sided spring guide 51 may be provided at each end of the series arrangement. The spring guides 51/53 thus also form in particular a defined guide and a protection for the pull rod or cord 21.

FIG. 5b shows a cross-section through an embodiment of a walking aid 30 according to the invention as represented in FIG. 5a, in which details can be seen more clearly. The labelled elements correspond to those that have ben explained previously and elsewhere.

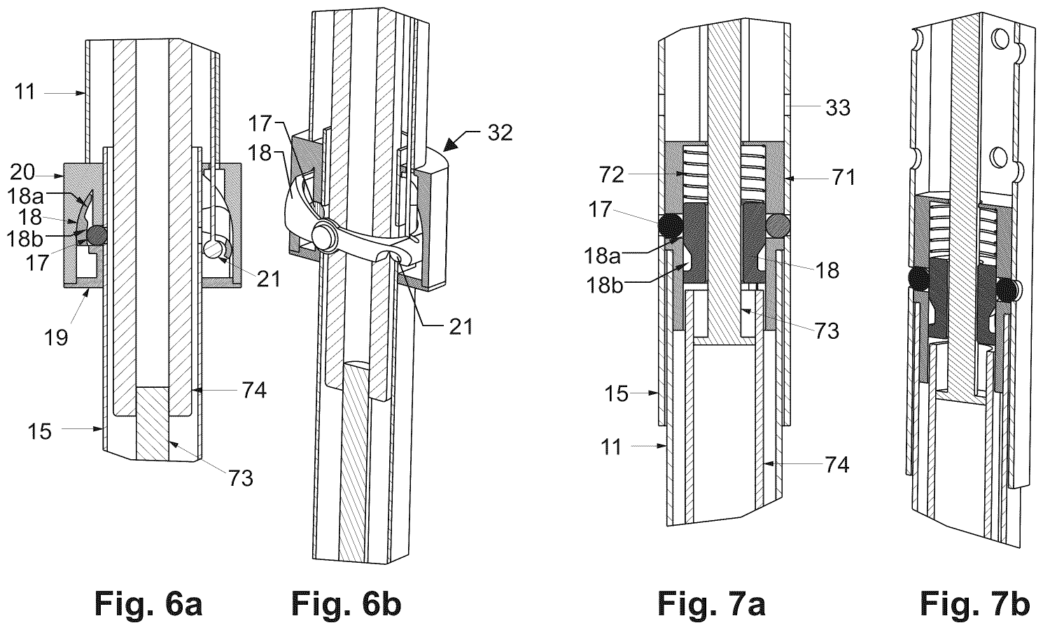

FIG. 6a is an embodiment of the slide 18, in which the movement thereof between engagement of the first level 18a or second level 18b—that is to say the displacement of the slide—is brought about with a tilting and rotating movement about a pivot point. In this context, the angle of the slide motion is preferably small, e.g., less than 30 degrees. (Each movement may be seen as a revolution about an instantaneous centre of rotation, which may also be located in the infinite.)

The embodiment shows the function also with only a single pull cord 21 for exemplary purposes. The embodiment shown also features as an example only a single locking mechanism on one side of the tubes, and not an opposing, double locking mechanism as in FIGS. 3 and 4.

In a slide housing 20 of the apparatus 32 which is closed by a slide cover 19, the slide 18 is realised as a tiltable and rotatable element. The slide 18 in turn includes: A first level 18a—with which it holds the engaging element 17 in a recess 33 on the adjusting tube 15 in forced locking manner; and: A second level 18b—with which the engaging element 17, and therewith also the adjusting tube 15 is released, so that the lengthwise adjustment of the walking aid is enabled. Again, there is a corresponding transition between the levels. A cylinder 74, a piston 73 and a piston rod 73 of a gas pressure spring 5 are also labelled here.

FIG. 6b shows a different view of a walking aid design 30 of FIG. 6a. The labelled elements correspond to those that have been explained previously and elsewhere.

As shown for exemplary purposes in FIG. 7a, the identified elements may also be arranged and used inversely/mirror-symmetrically in the same operating mode according to the invention within the scope of the invention. In particular, inside and outside and top and bottom may be inverted for example in other embodiments according to the invention. For example, in this embodiment—the reverse of earlier ones—the main tube 11 is arranged inside the adjusting tube 15. Functionally independently thereof, the apparatus 32 with the engaging element 17 and the slide 18 in the variant shown is arranged inside both tubes 15,11. The slide 18 is embodied here in the basic shape of a hollow cylinder. In the arrester block 71, in which the slide 18 is moved, a spring 72 is represented here too, and holds the slide 18 in locked resting position, in which the first level 18a thereof the engaging element 17—in this case a ball 17—engages in the recess 33 of the adjusting tube 15, and consequently locks main tube 11 and adjusting tube 15 with respect to each other. When the slide 18 moves, so that the level 18b of the slide 18 interacts with the engaging element 17 (not shown), the adjusting tube is released and change of length is possible. In such a case, one, two oppositely positioned or also more engaging element(s) 17 may be present and may preferably be held loose in a cage of the apparatus 32.

These embodiments of FIGS. 6a, 6b and FIGS. 7a, 7b also represent ideal solutions especially for circular main tubes 11 and/or adjusting tubes 15.

FIG. 7b shows another view of a walking aid design 30 of FIG. 7a. The labelled elements correspond to those that have been explained previously and elsewhere.

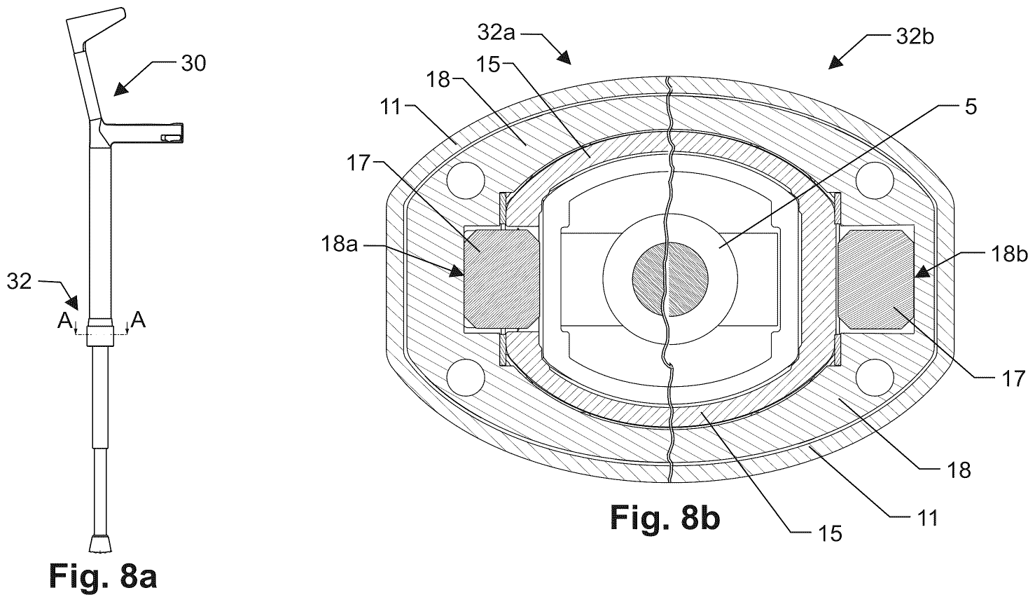

FIG. 8a is intended to show the position of the following cross-sectional representation A-A through the apparatus 32 of an embodiment, similarly to FIG. 2a.

FIG. 8b shows a variant of the previously marked cross-section through the apparatus 32. Here, a dividing line separates the locked apparatus state 32a in the left half of the figure from the unlocked apparatus state 32b during the length change 40 in the right half of the figure.

In the locked state 32a, the engaging element 17—in this case a cylindrical roller 17—engages in a recess 33 on the adjusting tube, which recess 33 is preferably not as high as the diameter of the roller element 17. Induced by the first level 18a of the slide 18, which is engaged here, the engaging element 17 engages under force, and main tube 11 is locked with respect to the adjusting tube 15. This locked position of the slide 18 is arrived at through non-actuation of the control element 1 on the separately arranged handgrip 35 and is preferably transmitted via a mechanical, in particular a purely mechanical mechanism.

In the unlocked state 32b, the engaging element 17 does not engage in a recess 33 on the adjusting tube under force, but is loose and free, and can get out of the recess during lengthwise movement or under longitudinal force of the two tubes towards each other, since now the second level 18b of the slide 18 is engaged, and enables the engaging element 17 to do this, so that the engaging element 17 rests or rests freely on the outer surface of the adjusting tube 15 (on a lengthwise region without a recess 33). Thus, the main tube 11 is unlocked with respect to the adjusting tube 15 and the length of the walking aid can be adjusted. This unlocked position of the slide 18 is arrived at through actuation of the control element 1 on the separately arranged handgrip 35 and is preferably transmitted via a mechanical, in particular a purely mechanical mechanism.

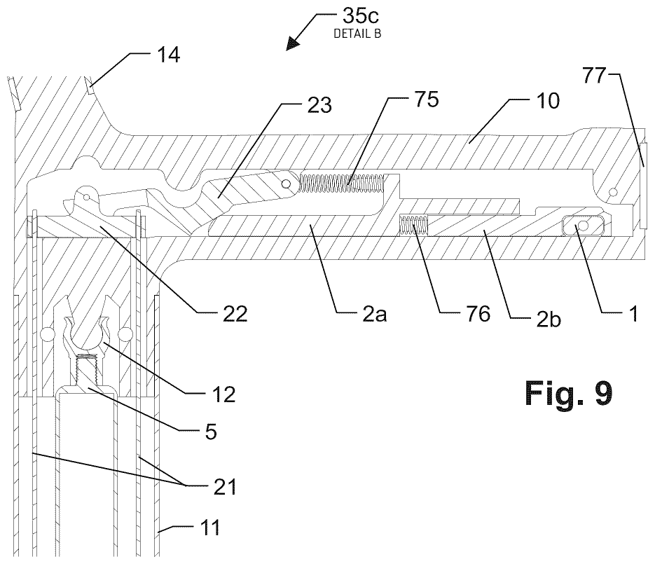

FIG. 9 shows a partial cutaway cross-section of an embodiment of a walking aid 30 according to the invention—in particular the handgrip region in detail B, similarly to FIG. 3b and FIG. 4b, but in an embodiment with identical primary function but enhanced safety features. The elements described previously, such as the handgrip plate 10, cord 21 or pull rod, balance 22, rocker 23, collar tube 14, main tube 11, spring element 5, are provided for functionally similar purposed to those previously described as part of the mechanism for moving the slide 18 of the apparatus 32, although their physical shape and geometrical configuration may be different in this variant. The gas pressure spring 5 shown in this example is supported at top and/or bottom on a ball pocket 12, but in this variant a different bearing arrangement and/or a different spring element may also be used in this area. In this enlarged detail view of an enhanced embodiment of the handgrip 35c, the mechanism—by means of which the slide 18 is moved remotely, in particular around a corner between main tube 11 and handgrip 35 when the control element 1 is actuated—is constructed differently from before. Here again, the control element 1 and the mechanism connected thereto are shown with the apparatus 32 in the locked position—that is to say the control element 1 is not actuated. In such case, the restoring spring 75 ensures that the locked position is the first stage travel position in the unactuated state of the control element and that the control element returns to this unactuated state after it is released. In the example shown, a two-part pressure bar 2a, 2b connected to the control element 1 (not shown) acts on a rocker 23 inside the grip core 10, with which rocker a pull cord 21—in this example two pull cords 21—can be moved over a balance 22, that is to say a tensile force can be exerted on the cords 21—substantially as before. The first part of the pressure bar 2a and the second part of the pressure bar 2b are connected to one another via a force limiting element 76, represented here for example as a force limiting spring 76. When the force limiting element 76 is configured correctly, the trigger force can be limited in such a way that the slide 18 can be prevented from being moved into the unlocked position if the control element 1 is actuated while the walking aid 30 is under load. When the walking aid 30 is supporting the load of the user, the necessary force for actuating the slide 18 is correspondingly greater than in the unloaded state, and the force limiting element 76 in this variant is also designed in such manner that this greater force on the slide 18 cannot be transferred to the mechanism when the control element 1 is actuated, but only the lesser force, which is required in the unloaded state. This serves to prevent the length adjustment unlocking from being triggered—for example inadvertently or accidentally—in the loaded state, which may in turn lead to falls or injuries. In this variant, the control element 1 may again be designed with safety interlock—for example in such a way that operation can only be enabled by pressing and sliding the device, or similar. However, particularly with the force limiting element 76 this does not have to be the case, since this already provides a safeguard against unintentional triggering in dangerous situations.

A permanent magnet 77 is shown in the region of the handgrip 35 in this embodiment, but it can also be used in combination with other embodiments. It is designed and arranged so that two walking aids 30 can be held together thereby, and/or one or both walking aids 30 can be secured against a metal object to prevent them falling over. To make operation easier, if a free hand is needed, for example, the second walking aid 30 may be attached to the first walking aid 30 with the permanent magnet 77. The actual position of the permanent magnet 77 in the region of the handgrip 25 may vary or it may be adapted to a specific configuration of the walking aid 30 and/or the handgrip 35, but it is preferably located on the front end of the handgrip 35.

It will be evident to the person skilled in the art that the embodiments and concepts described herein and illustrated in various figures within the meaning of the invention can also be combined and interchanged in ways other than those shown.

### List of Reference Numerals

1 OPERATING ELEMENT, ACTUATING ELEMENT, THUMB SLIDE, SWITCH, BUTTON, LEVER, OPTIONALLY WITH SAFETY LOCKING MECHANISM
2, 2a, PRESSURE BAR, FIRST AND SECOND PRESSURE BAR PART
2b
3 SPRING FASTENING, BOTTOM
4 FOOT, RUBBER, SLIP PROTECTION, SPIKE
5 GAS PRESSURE SPRING, SPRING ELEMENT
6 SLIDE, TOP
7 SLIDE, BOTTOM
8 GRIP PLATE, LEFT
9 GRIP PLATE, RIGHT
10 GRIP CORE
11 MAIN TUBE
12 BALL POCKET
13 COLLAR (optional)
14 COLLAR TUBE (optional)
15 ADJUSTABLE TUBE, MIDDLE TUBE, INTERIOR TUBE
16 BOTTOM TUBE, BASE TUBE
17 ROLLER
18 SLIDE, ROCKER SLIDE
18a FIRST SLIDE LEVEL (LOCKED)
18b TRANSITION FROM FIRST TO SECOND SLIDE LEVEL
18c SECOND SLIDE LEVEL (RELEASED)
19 SLIDE COVER
20 SLIDE HOUSING
21 STEEL CORD, CORD, PULL ROD
22 BALANCE
23 ROCKER
24 TENSION PLATE
30 WALKING AID, WALKING STICK, CANE, STANDING-UP AID,
30a WALKING AID EXTENDED (MAXIMUM LENGTH)
30b WALKING AID RETRACTED (MINIMUM LENGTH)
32 APPARATUS, LOCKING MECHANISM
33 LENGTH POSITIONS, STAGES, DETENTS, SETTINGS
35, HANDGRIP, HANDGRIP VARIANTS
35a,
35b,
35c
40 LENGTH ADAPTATION
51 SPRING GUIDE, ONE-SIDED
52 SPRING
53 SPRING GUIDE, TWO-SIDED
71 ARRESTER BLOCK
72 SPRING WITHOUT LOAD
73 GAS PRESSURE SPRING ROD, PISTON ROD
74 GAS PRESSURE SPRING CYLINDER
75 OPERATING LEVER RESTORING SPRING
76 FORCE LIMITING ELEMENT, OPERATING LEVER FORCE LIMITING ELEMENT
77 PERMANENT MAGNET

1. A walking aid (30), with an apparatus (32) for changing length (40) by means of a control element (1) on a handgrip (35) of the walking aid (30), designed with
a main tube (11) and
an adjusting tube (15) movable in the lengthwise direction with respect thereto,
which are slidable into one another for changing length (40), and
which are lockable with and disengaged from one another with the apparatus (32) for changing length,
wherein this apparatus (32) includes:
a slide (18),
which is movable by means of a mechanism by the separately arranged control element (1), and which has a transition (18c) from a first level (18a) to a second level (18b) that is substantially orthogonal the direction of movement thereof, and
an engaging element (17), which can be brought
into a locked position (32a) in the region of the first level (18a), in which the engaging element (17) engages in a recess or indentation (33) of the adjusting tube (15), or
into an unlocked position (32b) in the region of the second level (18b), in which the recess or indentation (33) of the adjusting tube (15) can be released by the engaging element (17),
by actuation of the slide (18).

2. The walking aid (30) according to claim 1, wherein the slide (18) is moved parallel to the main tube (11),
wherein the slide (18) is biased into the locked position (32a) by a spring element (72).

3. The walking aid (30) according to claim 1, wherein the apparatus (32) is arranged on the end of the main tube (11) farthest from the handgrip (35), and/or the mechanism is designed with a pull cord (21) in the interior of the main tube (11).

4. The walking aid (30) according to claim 1, wherein
the control element (1) actuates the movement of the slide (18) purely mechanically via a lever assembly (22,23) in the interior of the handgrip (35), wherein the lever assembly (22,23) forms a safety interlock that protects against unintentional unlocking, and/or
wherein the control element (1) is arranged on the side of the handgrip (35) of the walking aid (30) in such manner that it can be operated with by the user with a thumb while holding the handgrip (35).

5. The walking aid (30) according to claim 1, wherein the main and adjusting tubes (11,15) have a non-circular cross-section, specifically wherein the adjusting tube (15) has a flat/level cross-section in the region of the engaging element (17) (which moves over it).

6. The walking aid (30) according to claim 1, wherein one engaging element (17) is arranged on each side of the adjusting tube (15).

7. The walking aid (30) according to claim 1, wherein
a spring element (5) is arranged in the interior of main tube (11) and adjusting tube (15), by means of which the main tube (11) and adjusting tube (15) are connected displaceably with respect to one another, wherein the spring element (5) brings the length adaptation (40) of main tube (11) with respect to adjusting tube (15) into an expanded first stage travel position in unloaded state.

8. The walking aid (30) according to claim 1, wherein the spring element (5) is a gas pressure spring, designed with a damped/limited extension speed and/or with a force progression that is substantially constant over the travel path.

9. The walking aid (30) according to claim 1, wherein the spring element (5) is designed with a series arrangement of at least two single compression springs (52), which are connected to each other by gliding elements/rings (51,52) and are fitted in the interior of the walking aid (30).

10. The walking aid (30) according to claim 1, wherein at least one further intermediate latching position (30c) of the apparatus (32) is provided/designed, wherein the adjusting tube (15) has multiple recesses or indentations (33) for distinct, differing length adaptations (40).

11. The walking aid (30) according to claim 1, wherein the slide (18) and/or the handgrip (35) provides an indicator that is visible from the outside, or is connected with such an indicator, on which it is can be seen that it is in the locked position (32a) and/or the unlocked position (32b).

12. The walking aid (30) according to claim 11, wherein
the handgrip (35) is arranged on the end of the main tube (11) and/or
a collar tube (14) is arranged on the handgrip (35) above the main tube (11) and with a collar (13) on the free end thereof, and/or
an armpit support is arranged on the handgrip (35) above the main tube (11).

13. The walking aid (30) according to claim 1, wherein at least the adjusting tube (15) or the main tube (11) is constructed in two parts, with a snap-in base tube (16) that is displaceable therein and is operable locally at least in discrete stages.

14. A method for changing the length of a walking aid (30) by means of a handgrip control element (1) with
actuation of the control element (1) on the handgrip (35) of the walking aid (30),
movement of a slide (8) arranged separately from the handgrip (35) by actuation of the control element (1) via a mechanical mechanism,
release of an engaging element (17) from a latching position (33a) in an adjusting tube (15) of the walking aid (30) via the slide (8),
movement of the adjusting tube (15) with respect to a main tube (11) into a different latching position (33b),
ending the actuation of the control element (1), and
moving a slide (18) back with a forced engagement of the engaging element (17) in the other latching position (33b).

15. The method according to claim 14, wherein a spring element (5) in the interior of the walking aid (30) moves the adjusting tube (15) into an expanded length in unloaded state.

16. The walking aid (30) according to claim 1, wherein the transition (18c) from the first level (18a) to the second level (18b) is a smooth transition and wherein the engaging element (17) is a roller element, a cylindrical roller or a ball.

17. The walking aid (30) according to claim 2, wherein the engaging element (17) is held loose in a cage, in a position above the recess or indentation (33), and/or the slide (18) holds the unlocked engaging element (17) in position.

18. The walking aid (30) according to claim 4, wherein the control element (1) is constructed with a force limiting element (76) which is designed in such manner that a force transmitted thereby is only sufficient to move the slide (18) when the walking aid (30) is not supporting the load of a user.

19. The walking aid (30) according to claim 12, wherein a permanent magnet (77) is present in the handgrip (35) or in the region of the handgrip, which magnet is designed and arranged to create a connection with a second walking aid (30) or with a metal object.

20. The walking aid (30) according to claim 13, wherein the base tube (16) is arranged inside the adjusting tube (15) and can be snapped into holes in different base length positions by means of spring lugs.
